(19) United States
(12) Patent Application Publication
(10) Pub. No.: US 2021/0399361 A1
(43) Pub. Date: Dec. 23, 2021

(54) BATTERY MODULE AND BATTERY SYSTEM

(71) Applicant: Prime Planet Energy & Solutions, Inc., Tokyo (JP)

(72) Inventors: Tomonori KUNIMITSU, Himeji-shi (JP); Junya YANO, Kato-shi (JP); Masato NAKAYAMA, Akashi-shi (JP); Taisuke HAMADA, Kasai-shi (JP); Jun ASAKURA, Kakogawa-shi (JP)

(21) Appl. No.: 17/352,363

(22) Filed: Jun. 21, 2021

(30) Foreign Application Priority Data
Jun. 22, 2020 (JP) 2020-106899

(51) Int. Cl. H01M 10/6551; H01M 10/613; H01M 10/647; H01M 50/209

(52) U.S. Cl. CPC H01M 10/6551; H01M 50/209; H01M 10/647; H01M 10/613

(57) ABSTRACT

A battery module includes: a stack of a plurality of battery cells; an end plate provided at an axial end portion of the stack of the battery cells; a substrate provided on a side opposite to the battery cells with respect to the end plate; a mounted component provided on the substrate; and a heat transfer body that is provided between the substrate and the end plate and that transfers, to the end plate, heat generated from the mounted component.

This nonprovisional application is based on Japanese Patent Application No. 2020-106899 filed on Jun. 22, 2020, with the Japan Patent Office, the entire contents of which are hereby incorporated by reference.

### BACKGROUND OF THE INVENTION

### Field of the Invention

The present disclosure relates to a battery module and a battery system.

### Description of the Background Art

Japanese Patent No. 5621765 (PTL 1) discloses a structure in which a substrate having an electronic component mounted thereon is provided on an end plate of a battery module.

Japanese Patent No. 6015600 (PTL 2) discloses a structure that has a heat dissipation plate for dissipating heat of a circuit board having an electronic component mounted thereon and that thermally couples the heat dissipation plate to an end plate.

In a battery module including a plurality of battery cells, a mechanism for equalizing the cells is provided. As an example of such a mechanism, a passive balance method has been known in which variation in battery capacities of cells is equalized by power consumption of a discharging resistor (equalization resistor). In the passive balance method, a substrate having the resistor mounted thereon generates heat due to the power consumption by the equalization resistor. In order to prevent the heat generation from becoming too large, it is required to improve heat dissipation efficiency.

PTL 1 discloses that the substrate having an electronic component mounted thereon is provided on the end plate of the battery module, but does not discloses a specific configuration for improving heat dissipation efficiency.

PTL 2 also does not disclose a specific configuration that can sufficiently deal with expansion of a battery cell or vibration caused due to an external environment (for example, vibration when mounted on a vehicle), for example.

### SUMMARY OF THE INVENTION

An object of the present disclosure is to provide a battery module and a battery system, in each of which heat dissipation efficiency of a substrate having an electronic component mounted thereon is improved.

A battery module according to the present disclosure includes: a stack of a plurality of battery cells; an end plate provided at an axial end portion of the stack of the battery cells; a substrate provided on a side opposite to the battery cells with respect to the end plate; a mounted component provided on the substrate; and a heat transfer body that is provided between the substrate and the end plate and that transfers, to the end plate, heat generated from the mounted component.

A battery system according to the present disclosure includes: a plurality of the above-described battery modules, wherein each of the plurality of the battery modules include a monitoring circuit that detects voltages of the battery cells included in the battery module; and a controller individually connected to each of the monitoring circuits included in the plurality of the battery modules.

According to the present disclosure, there can be provided a battery module and a battery system, in each of which heat dissipation efficiency of a substrate having an electronic component mounted thereon is improved.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a diagram schematically showing a configuration of a battery module according to one embodiment of the present disclosure.

FIG. 2 is a diagram showing a position of a substrate when an end plate shown in FIG. 1 is viewed in a direction of arrow II in FIG. 1.

FIG. 3 is a diagram showing an arrangement of the substrate shown in FIG. 2 on a component mounting surface.

FIG. 4 is a diagram showing an arrangement on a rear surface of the substrate shown in FIG. 2.

FIG. 5 is a diagram schematically showing a configuration of a modification of the battery module.

FIG. 6 is a diagram showing exemplary irregularities provided on the end plate.

FIG. 7 is a diagram showing another exemplary irregularities provided on the end plate.

FIG. 8 is a cross sectional view showing a through hole and a heat transfer portion each provided in the substrate.

FIG. 9 is a diagram showing a heat dissipation fin provided on the end plate.

FIG. 10 is a diagram schematically showing a configuration of a battery system according to one embodiment of the present disclosure.

### DESCRIPTION OF THE PREFERRED EMBODIMENTS

Hereinafter, embodiments of the present disclosure will be described. It should be noted that the same or corresponding portions are denoted by the same reference characters and may not be described repeatedly.

It should be noted that in the embodiments described below, when reference is made to number, amount, and the like, the scope of the present disclosure is not necessarily limited to the number, amount, and the like unless otherwise stated particularly. In the embodiments described below, each component is not necessarily essential to the present disclosure unless otherwise stated particularly.

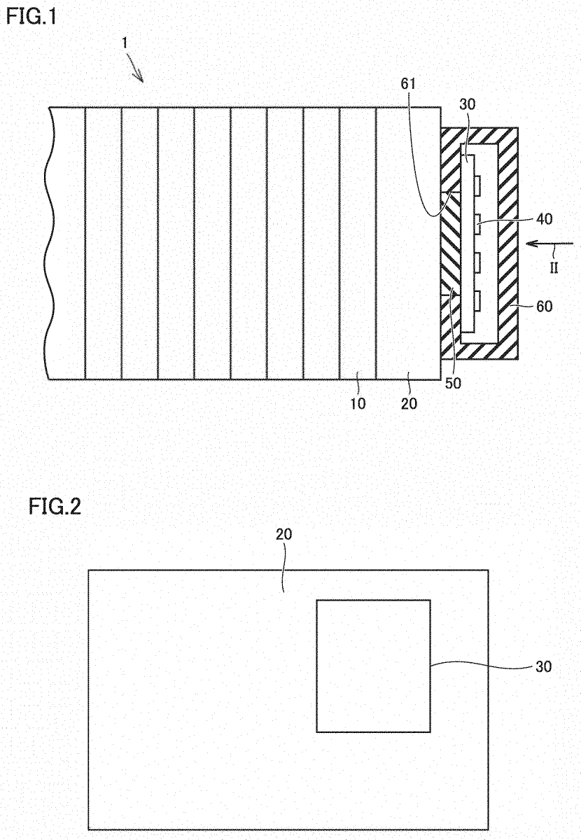

FIG. 1 is a diagram schematically showing a configuration of a battery module 1 according to the present embodiment. As shown in FIG. 1, battery module 1 includes: a stack of a plurality of battery cells 10, an end plate 20; a substrate 30; mounted components 40; a heat transfer body 50; and a case 60.

Each of battery cells 10 is a prismatic cell having six surfaces. As an example, battery cell 10 is a lithium ion battery, but may be a nickel-metal hydride battery.

End plate 20 is provided at an axial end portion of the stack of battery cells 10. End plate 20 is composed of a metal such as aluminum, for example. End plate 20 is provided at each of ends of the stack of the plurality of battery cells 10 in the axial direction (stacking direction). Battery cells 10 and end plate 20 are constrained in the stacking direction, thereby constructing battery module 1.

Substrate 30 is provided on an outer side with respect to end plate 20 (a side opposite to battery cells 10). Substrate 30 is constituted of a member having an insulation property. Mounted components 40, each of which is an electronic component, are provided on a mounting surface (a right side surface in FIG. 1) of substrate 30. In the example of FIG. 1, mounted components 40 are provided only on one surface of substrate 30. An electric circuit that electrically connects mounted components 40 is formed on the surface of substrate 30.

Heat transfer body 50 is provided between end plate 20 and substrate 30. Heat transfer body 50 transfers, to end plate 20, heat generated from each of mounted components 40. Heat transfer body 50 has an electrical insulation function, and end plate 20 and substrate 30 are electrically insulated from each other by heat transfer body 50.

Case 60 accommodates substrate 30 and mounted components 40. Case 60 is fixed to end plate 20 by, for example, joining with a bolt or the like. Case 60 is composed of an insulating material such as a resin, for example. Case 60 is provided with an opening 61 on the end plate 20 side. Heat transfer body 50 is provided in opening 61.

Case 60 can be configured to cover a portion of connection to an external wiring. Thus, exposure of high voltage and entry of dust can be prevented.

By providing opening 61 only in a portion of the bottom surface of case 60 rather than a whole of the bottom surface of case 60, heat transfer body 50 can be provided while maintaining the strength of case 60, dust prevention characteristics, and workability in an installing process.

Hereinafter, heat transfer body 50 will be described more in detail. Heat transfer body 50 may be a solid, may be a semi-solid, or may be in the form of a paste. Heat transfer body 50 is constituted of a heat dissipation sheet, heat dissipation gel, heat dissipation silicon, or the like.

The heat dissipation sheet serving as an exemplary heat transfer body 50 may be a high-hardness sheet or may be a low-hardness sheet. Heat transfer body 50 (heat dissipation sheet) may be selected with more emphasis being placed on an insulation property or may be selected with more emphasis being placed on a heat dissipation property. Heat transfer body 50 may be a sheet material composed of a material such as an acryl-based material or a silicone-based material, or may be a carbon-fiber-based sheet material. For example, the carbon-fiber-based sheet material has high heat conductivity, and is suitable for the case where emphasis is placed on the heat dissipation property.

Since the temperature of substrate 30 is increased to about 100° C., heat transfer body 50 desirably has a performance that is not deteriorated even when the temperature is increased to about 100° C. From one point of view, a material that does not generate silicon gas such as siloxane gas is preferably used so as not to affect an electronic component around substrate 30.

For example, in the case of heat transfer body 50 composed of a resin-based material, the heat conductivity is about more than or equal to 1 W/m·K and less than or equal to 3 W/m·K. For example, in the case of heat transfer body 50 composed of a carbon-fiber-based material, the heat conductivity can be more than or equal to 10 W/m·K.

FIG. 1 shows an example in which substrate 30 and case 60 are in close contact with each other for convenience of illustration and description. The close contact between substrate 30 and case 60 also promotes heat dissipation from substrate 30 via case 60. However, a minute gap may be formed between substrate 30 and case 60 as long as end plate 20 and substrate 30 are joined to each other via heat transfer body 50.

When a heat dissipation sheet is used as heat transfer body 50, the heat dissipation sheet is pressed at the time of installation, and is joined to 20% or more and 30% or less. This leads to improved adhesion between the heat dissipation sheet and each of end plate 20 and substrate 30. By matching the thickness of the heat dissipation sheet compressed by 20% or more and 30% or less with the thickness of case 60 (for example, about 3 mm), the rear surface of substrate 30 and case 60 can be brought into close contact with each other.

Heat transfer body 50 preferably has an insulation property with respect to a voltage of more than or equal to the voltage of a battery system including battery module 1. For example, when an output of each battery cell 10 is 4.2 V and the battery system has 96 battery cells 10, heat transfer body 50 preferably has an insulation performance with respect to a voltage of more than or equal to 4.2 V×96=403.2 V. It should be noted that the system voltage of the battery system may be less than 403.2 V or may be more than or equal to 403.2 V.

In a more specific example, for example, a Hypersoft Heat Dissipation Material 6500H (heat transfer rate: about 3.0 W/m·K) manufactured by 3M (registered trademark) can be used as a heat dissipation sheet that constitutes heat transfer body 50 and that has high flame retardancy and low hardness (Asker C hardness: about 30).

Since heat transfer body 50 is in close contact with end plate 20 and substrate 30 in the structure shown in FIG. 1, heat generated by each of mounted components 40 on substrate 30 can be efficiently transferred to end plate 20 via heat transfer body 50, thus resulting in improved heat dissipation efficiency.

Further, by interposing heat transfer body 50 between end plate 20 and substrate 30, end plate 20 and substrate 30 are integrated, with the result that the high heat dissipation efficiency can be maintained even when battery cell 10 is expanded or vibration is applied to battery module 1.

By efficiently transferring the heat generated by substrate 30 to end plate 20, the heat generation of substrate 30 can be suppressed with a reduced size of substrate 30, with the result that substrate 30 can be disposed in a narrow space on end plate 20.

Further, due to the structure in which case 60 having substrate 30 accommodated therein is installed on end plate 20 of battery module 1, workability in installing and replacing substrate 30 is excellent. Further, since substrate 30 can be installed at a position separated from a bus bar provided on the upper surface of battery module 1, the position at which substrate 30 is provided is not restricted by the shape of the bus bar or the like, thus resulting in an improved degree of freedom in design.

Since the heat dissipation efficiency and the degree of freedom in design are improved as described above, further size reduction of battery module 1 can be attained.

FIG. 2 is a diagram showing a position of substrate 30 when end plate 20 is viewed in a direction of arrow II in FIG. 1. As shown in FIG. 2, substrate 30 is provided at a position separated from the center of end plate 20 in the width direction (leftward/rightward direction in FIG. 2) and the height direction (upward/downward direction in FIG. 2).

At the central portion of end plate 20, strain of end plate 20 due to expansion of battery cells 10 tends to be relatively large. When the strain of end plate 20 is large, adhesion between heat transfer body 50 and end plate 20 may be decreased, thus affecting the heat dissipation efficiency. By providing substrate 30 at the position separated from the center of end plate 20 as shown in FIG. 2, the effect of the strain of end plate 20 due to expansion of battery cells 10 can be reduced, thus resulting in improved heat dissipation efficiency.

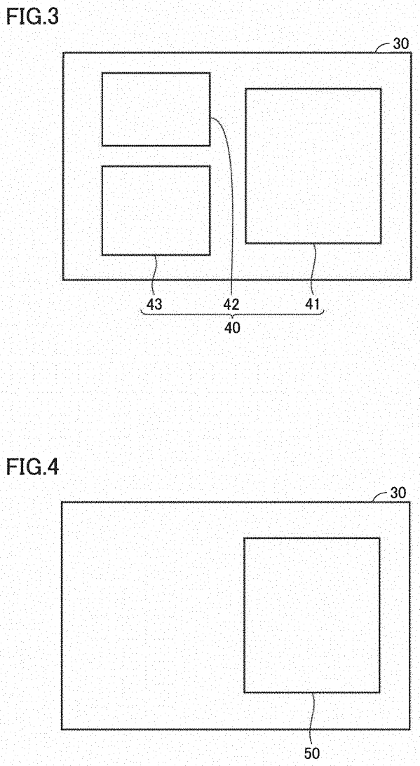

Next, arrangements of mounted components 40 on substrate 30 will be described with reference to FIGS. 3 and 4. FIG. 3 shows a state in which substrate 30 is viewed from the mounting surface side on which mounted components 40 are mounted.

FIG. 4 shows a state in which substrate 30 is viewed from the rear surface side opposite to the mounting surface.

As shown in FIG. 3, mounted components 40 are disposed on the mounting surface of substrate 30. Mounted components 40 include an equalization resistor 41, a communication circuit 42, and an ASIC 43. Equalization resistor 41 equalizes variation in battery capacities of battery cells 10 in battery module 1 by power consumption by equalization resistor 41. Communication circuit 42 communicates information with a battery ECU that controls a whole of the battery system. ASIC 43 includes an integrated circuit that controls mounted component 40 on substrate 30. It should be noted that communication circuit 42 may communicate information with a different battery module 1.

Equalization resistor 41 generates the largest amount of heat among equalization resistor 41, communication circuit 42, and ASIC 43. In other words, equalization resistor 41 is a mounted component 40 involving a relatively large heat generation amount, and each of communication circuit 42 and ASIC 43 is a mounted component 40 involving a relatively small heat generation amount as compared with equalization resistor 41. Equalization resistor 41 is a component involving the largest heat generation amount among the plurality of mounted components 40 mounted on substrate 30.

Since the heat generation amount of equalization resistor 41 is relatively large, the temperature of substrate 30 around equalization resistor 41 is also relatively high. In the present embodiment, heat transfer body 50 is provided on the rear surface side of substrate 30 at a region facing equalization resistor 41 as shown in FIG. 4. Thus, the relatively large amount of heat generated by equalization resistor 41 can be effectively transferred to end plate 20 via heat transfer body 50, with the result that the heat dissipation efficiency of each of substrate 30 and mounted components 40 can be effectively improved.

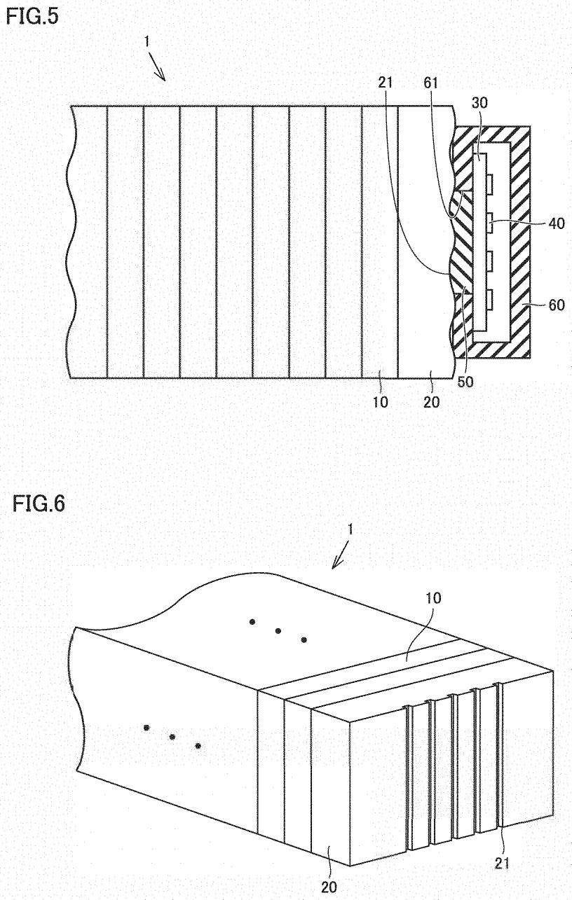

FIG. 5 is a diagram schematically showing a configuration of a modification of the battery module. In the modification shown in FIG. 5, a groove portion 21 is formed in the surface of end plate 20. Further, a portion of the surface of end plate 20 is formed in the form of a curved surface. That is, the curved surface or irregularities is/are formed in the surface of end plate 20 on the heat transfer body 50 side.

Since the surface of end plate 20 is in the form of the curved surface or in the form with the irregularities rather than a flat surface, a contact area between end plate 20 and heat transfer body 50 can be increased, thus resulting in improved heat dissipation efficiency. Further, since an air passage is formed above end plate 20, an escape passage for air bubbles is formed between end plate 20 and heat transfer body 50, thereby suppressing the heat dissipation efficiency from being decreased due to the air bubbles.

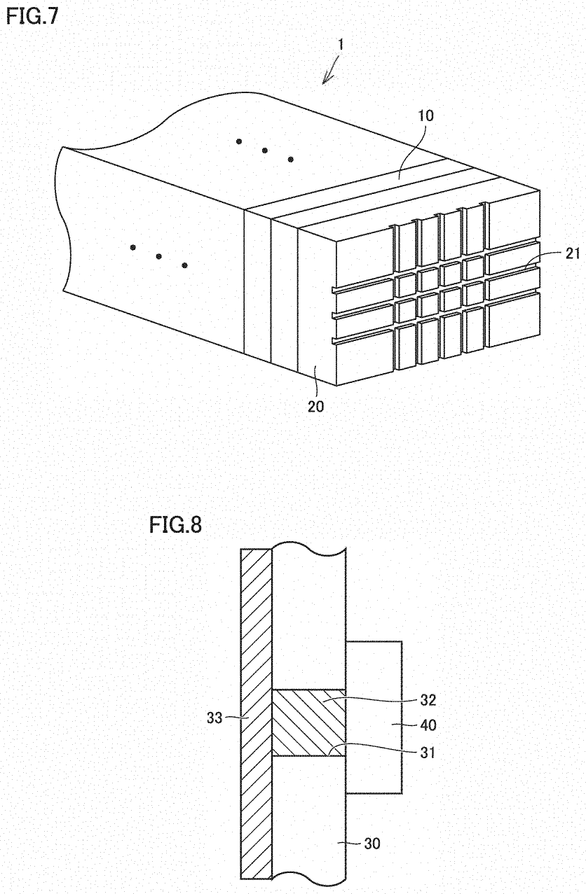

Each of FIGS. 6 and 7 shows a specific example of the irregularities provided in end plate 20. As shown in FIG. 6, a plurality of groove portions 21 may be formed along the height direction (first direction) of end plate 20. Alternatively, a plurality of groove portions 21 may be formed along the height direction (first direction) and the width direction (second direction orthogonal to the first direction) of end plate 20. The cross sectional shape of each groove portion 21 may be a quadrangular shape, a triangular shape, a semicircular shape, or another shape.

FIG. 8 is a cross sectional view of substrate 30. As shown in FIG. 8, substrate 30 is provided with: a through hole 31; a heat transfer portion 32 provided in through hole 31; and a metal layer 33 that is formed on a surface of substrate 30 opposite to mounted components 40 and that is connected to heat transfer portion 32.

Through hole 31 is formed directly below mounted component 40 (particularly, equalization resistor 41). Each of heat transfer portion 32 and metal layer 33 is composed of, for example, copper or the like. Heat transfer portion 32 does not need to completely fill through hole 31, and may be formed only on a wall surface of through hole 31. According to the structure shown in FIG. 8, heat of mounted component 40 is efficiently transferred to the rear surface side of substrate 30 via heat transfer portion 32 and metal layer 33, and is transferred to end plate 20 via heat transfer body 50. It should be noted that through hole 31 may be provided in the vicinity of mounted component 40.

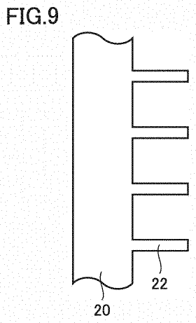

According to battery module 1 of the present embodiment, as described above, heat from substrate 30 and mounted component 40 can be efficiently transferred to end plate 20, thus resulting in improved heat dissipation efficiency. On this occasion, the temperature of end plate 20 is also increased. Therefore, the heat dissipation efficiency can be expected to be further improved by improving heat dissipation efficiency from end plate 20 to air. In order to improve the heat dissipation efficiency from end plate 20, end plate 20 may be provided with a heat dissipation fin 22 as shown in FIG. 9.

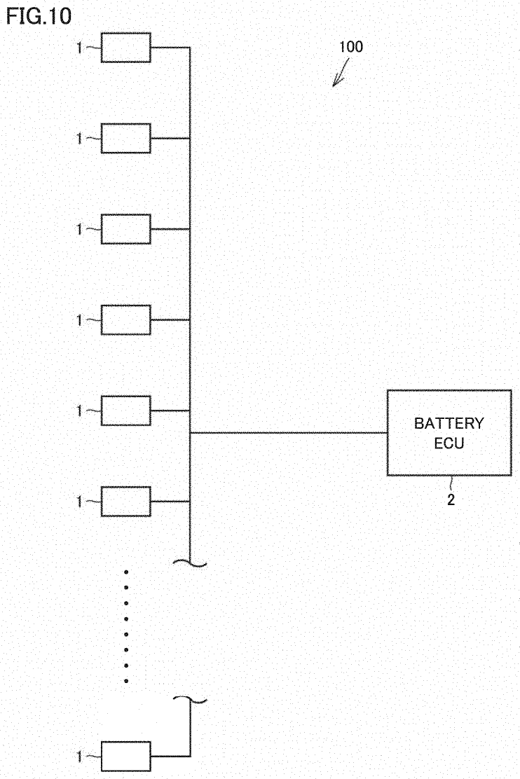

FIG. 10 is a diagram schematically showing a configuration of a battery system according to the present embodiment. As shown in FIG. 10, battery system 100 includes a plurality of battery modules 1 and a controller 2 (battery ECU).

Each of the plurality of battery modules includes a monitoring circuit that detects voltages of battery cells 10 included in battery module 1. Controller 2 is individually connected to each of the monitoring circuits included in the plurality of battery modules 1.

In distributed control in which the plurality of battery modules 1 are individually connected to controller 2, substrate 30 having mounted components 40 thereon needs to be provided in each of battery modules 1. According to the structure of the present embodiment, the heat dissipation efficiency of each of substrate 30 and mounted component 40 in each battery module 1 can be improved.

Although the present invention has been described and illustrated in detail, it is clearly understood that the same is by way of illustration and example only and is not to be taken by way of limitation, the scope of the present invention being interpreted by the terms of the appended claims.

What is claimed is:

1. A battery module comprising:
a stack of a plurality of battery cells;
an end plate provided at an axial end portion of the stack of the battery cells;
a substrate provided on a side opposite to the battery cells with respect to the end plate;
a mounted component provided on the substrate; and
a heat transfer body that is provided between the substrate and the end plate and that transfers, to the end plate, heat generated from the mounted component.

2. The battery module according to claim 1, wherein the mounted component is mounted only on one surface of the substrate.

3. The battery module according to claim 1, wherein the substrate is provided at a position separated from a center of the end plate in a width direction.

4. The battery module according to claim 1, wherein the substrate is provided at a position separated from a center of the end plate in a height direction.

5. The battery module according to claim 1, wherein the substrate is provided at a position separated from a center of the end plate in a width direction and a height direction.

6. The battery module according to claim 1, wherein the substrate is provided with a through hole, a heat transfer portion provided in the through hole, and a metal layer that is formed on a surface of the substrate opposite to the mounted component and that is connected to the heat transfer portion.

7. The battery module according to claim 1, wherein the heat transfer body has an electrical insulation function.

8. The battery module according to claim 1, further comprising a case that accommodates the substrate and the mounted component, wherein the case is fixed to the end plate.

9. The battery module according to claim 8, wherein the case is provided with an opening on the end plate side, and the heat transfer body is provided in the opening.

10. The battery module according to claim 1, wherein a curved surface or irregularities is/are formed in a surface of the end plate on the heat transfer body side.

11. The battery module according to claim 1, wherein the end plate is provided with a heat dissipation fin.

12. A battery system comprising:
a plurality of the battery modules according to claim 1, wherein each of the plurality of the battery modules includes a monitoring circuit that detects voltages of the battery cells included in the battery module; and
a controller individually connected to each of the monitoring circuits included in the plurality of the battery modules.
